(19) United States
(12) Patent Application Publication
(10) Pub. No.: US 2014/0141241 A1
(43) Pub. Date: May 22, 2014

(54) HALOGEN-FREE HEAT AGING-RESISTANT FLAME-RETARDANT RESIN COMPOUND AND WIRE AND CABLE USING THE SAME

(71) Applicant: HITACHI METALS, LTD., Tokyo (JP)

(72) Inventors: Hajime NISHI, Hitachi (JP); Kenichiro FUJIMOTO, Hitachi (JP); Kentaro SEGAWA, Hitachi (JP); Yoshiaki NAKAMURA, Hitachi (JP)

(73) Assignee: HITACHI METALS, LTD., Tokyo (JP)

(21) Appl. No.: 14/084,458

(22) Filed: Nov. 19, 2013

(30) Foreign Application Priority Data
Nov. 20, 2012 (JP) 2012-254073

(51) Int. Cl. H01B 3/44; C08L 23/06

(52) U.S. Cl. CPC H01B 3/441; C08L 23/06
USPC 428/379; 524/101

(57) ABSTRACT

A halogen-free heat aging-resistant flame-retardant resin compound includes a mixture of 100 parts by mass of polyolefin-based resin, 100 to 250 parts by mass of metal hydroxide, and 2 to 5 parts by mass of an antioxidant including a first antioxidant having a melting point of not less than 200 degrees Celsius and a mean particle diameter of not greater than 10 μm solely or a combination with a second antioxidant, and the mixture is cross-linked.

The present application is based on Japanese Patent Application No. 2012-254073 filed on Nov. 20, 2012, the entire contents of which are incorporated herein by reference.

### BACKGROUND OF THE INVENTION

1. Field of the Invention

The present invention relates to a halogen-free heat aging-resistant flame-retardant resin compound as well as a wire and a cable using the same, more particularly, to a halogen-free heat aging-resistant flame-retardant resin compound with excellent flame resistance, heat aging resistance, and safety, which is useful as a cable insulation material, as well as a wire and a cable using the same

2. Description of the Related Art

Conventionally, as an insulating coating material for an insulated wire to be used in rolling stocks or the like, vinyl chloride resins having excellent flame retardancy in general have been used widely.

While the vinyl chloride resin has flame retardancy, there is a disadvantage in that the vinyl chloride resin includes a halogen element in the molecule and releases toxic halogen gas into the atmosphere at the time of fire or incineration disposal of the rolling stocks.

In recent years, halogen-free flame-retardant resin compounds comprising polyolefin-based resin as base resin added with metal hydroxide as a flame retardant have been developed from the aforementioned background.

For example, as a method for achieving heat aging resistance, a technique of compounding a phenolic antioxidant to a halogen-free flame-retardant resin compound, a technique of compounding a sulfuric antioxidant (e.g. Japanese Patent No. 4255368) to a halogen-free flame-retardant resin compound have been proposed.

### SUMMARY OF THE INVENTION

However, for EN standard (European Standard) wires application of which has been expanded mainly in Europe and the United States in recent years, in addition to Vertical Flame Test (VFT), which is a very strict flame-retardant standard, a long-term heat aging resistance of more than 20,000 hours at a temperature of 120 to 125 degrees Celsius and reduction of toxic gases, which are harmful to humans and generated during the combustion, such as hydrogen cyanide, carbon monoxide, carbon dioxide, nitrogen oxides and sulfur dioxide are also demanded.

Therefore, it is an object of the invention to provide to a halogen-free heat aging-resistant flame-retardant resin compound with excellent flame resistance, heat aging resistance, and safety, which is useful as a cable insulation material, as well as a wire and a cable using the same.

According to a feature of the present invention, a halogen-free heat aging-resistant flame-retardant resin compound comprises:
a mixture of 100 parts by mass of polyolefin-based resin, 100 to 250 parts by mass of metal hydroxide, and 2 to 5 parts by mass of an antioxidant including a first antioxidant having a melting point of not less than 200 degrees Celsius and a mean particle diameter of not greater than 10 μm solely or in combination with a second antioxidant, and the mixture being cross-linked.

In the halogen-free heat aging-resistant flame-retardant resin compound, the polyolefin-based resin may be at least one selected from the group consisting of polypropylene, high-density polyethylene, linear low-density polyethylene, very low-density polyethylene, low-density polyethylene, α-olefin (co)polymer, ethylene-vinyl acetate copolymer, ethylene ethyl acrylate copolymer, ethylene-propylene copolymer rubber, and ethylene-propylene-diene ternary copolymer rubber.

In the halogen-free heat aging-resistant flame-retardant resin compound, the metal hydroxide may be magnesium hydroxide or aluminum hydroxide.

In the halogen-free heat aging-resistant flame-retardant resin compound, the first antioxidant may be 1,3,5-tris(3′-5′-di-tert-butyl-4′-hydroxybenzyl)isocyanurate and the second antioxidant may be at least one selected from the group consisting of pentaerythrityl-tetrakis[3-[3,5-di-tert-butyl-4-hydroxyphenyl]propionate], thiodiethylene bis [3-[3,5-di-tert-butyl-4-hydroxyphenyl]propionate], and tetrakis[methylene-3-(dodecylthio)propionate]methane.

In the halogen-free heat aging-resistant flame-retardant resin compound, an elongation at break after storage for 20,000 hours at temperature of 120 degrees Celsius is preferably expected to 50% or more by Arrhenius plot based on a maximum time for which an elongation at break of an article stored at 180 to 140 degrees Celsius is 50% or more, and a toxicity index is 3.0 or less.

According to another feature of the invention, a wire comprises a conductor covered with the halogen-free heat aging-resistant flame-retardant resin compound.

According to a still another feature of the invention, a cable comprises a sheath comprising the halogen-free heat aging-resistant flame-retardant resin compound.

### Effects of the Invention

According to the invention, it is possible to provide to a halogen-free heat aging-resistant flame-retardant resin compound with excellent flame resistance, heat aging resistance, and safety, which is useful as a cable insulation material, and wire and cable using the same.

Further, it is possible to provide a wire and a cable with excellent safety, which comply the Vertical Flame Test (VFT) as a very strict flame-retardant standard, provide a long-term heat aging resistance of more than 20,000 hours at a temperature of 120 to 125 degrees Celsius and suppress the generation of toxic gases such as hydrogen cyanide, carbon monoxide, carbon dioxide, nitrogen oxides and sulfur dioxide to a low level during the combustion, while retaining mechanical properties, oil resistance, and acid-alkaline resistance.

### BRIEF DESCRIPTION OF THE DRAWINGS

Next, the present invention will be explained in more detail in conjunction with appended drawings, wherein:

FIG. 1 is a cross sectional view showing a wire using a halogen-free heat aging-resistant flame-retardant resin compound in an embodiment of the present invention; and

FIG. 2 is a cross sectional view showing a cable using the halogen-free heat aging-resistant flame-retardant resin compound in the embodiment of the present invention.

### DETAILED DESCRIPTION OF THE PREFERRED EMBODIMENT

Next, a preferred embodiment according to the present invention will be described in more detail in conjunction with appended drawings.

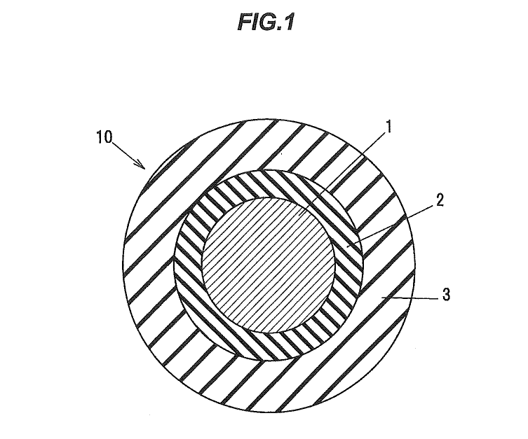

Referring to FIG. 1, an example of a wire using a halogen-free heat aging-resistant flame-retardant resin compound according to the present invention will be explained below.

FIG. 1 shows a wire (electric wire) 10 comprising a tin-plated copper conductor 1, an inner insulating layer 2 covering an outer periphery of the tin-plated copper conductor 1, and an outer insulating layer 3 provided around the inner insulating layer 2 by extrusion-coating, in which the outer insulating layer 3 is made of a halogen-free heat aging-resistant flame-retardant resin compound of the present invention.

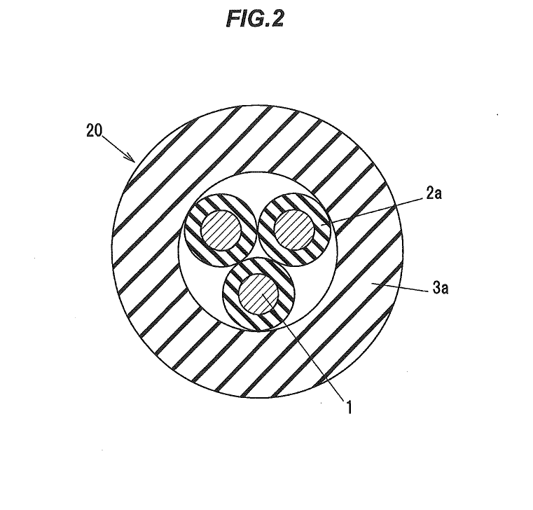

FIG. 2 is a cross sectional view showing a cable 20 comprising a plurality of wires, each of which comprises a tin-plated copper conductor 1 and an insulating layer 2a covering an outer periphery of the tin-plated copper conductor 1, and a sheath 3a provided around the plurality of wires. The halogen-free heat aging-resistant flame-retardant resin compound of the present invention may be applied to the material of the insulating layer 2a. Alternatively, the halogen-free heat aging-resistant flame-retardant resin compound of the present invention may be applied to the material of the sheath 3a, and the cable 20 using the halogen-free heat aging-resistant flame-retardant resin compound of the present invention as the material of the sheath 3a exhibits the flame retardancy more excellent than the cable 20 using the halogen-free heat aging-resistant flame-retardant resin compound of the present invention as the material of the insulating layer 2a.

The halogen-free heat aging-resistant flame-retardant resin compound of the present invention comprising a mixture consisting essentially of 100 parts by mass of polyolefin-based resin, 100 to 250 parts by mass of metal hydroxide, and 2 to 5 parts by mass of an antioxidant including a first antioxidant having a melting point of not less than 200 degrees Celsius and a mean particle diameter of not greater than 10 μm solely or in combination with the other antioxidant, and the mixture being cross-linked.

As the antioxidant to be used in the present invention, an antioxidant having a melting point of not less than 200 degrees Celsius and a mean particle diameter of not greater than 10 μm is used as the first antioxidant solely or in combination with the other antioxidant. 2 to 5 parts by mass of the antioxidant(s) in total are mixed with 100 parts by mass of polyolefin-based resin and 100 to 250 parts by mass of metal hydroxide for the use.

The reason for using the antioxidant having the melting point of not less than 200 degrees Celsius is to improve the heat aging resistance at high temperature (e.g. 200 degrees Celsius). The reason for setting the mean particle diameter to be not greater than 10 μm is to enhance dispersibility within the resin, thereby to achieve the improvement in heat resistance more effectively.

The function of the antioxidant may be capturing of radicals generated in the oxidative degradation of the polymer (phenolic antioxidant) or decompound of peroxide (sulfuric antioxidant). It is possible to suppress the oxidative degradation that occurs in the vicinity of each portion of the polymer more efficiently by improving the dispersion of the antioxidant(s).

As to the additive amount of the antioxidant(s), it has been known that addition of the antioxidant greater than a certain amount will be sufficient to suppress the oxidative degradation of the polymer, while an excessively added antioxidant tends to act as a pro-oxidant at high temperatures to accelerate the degradation rather than achieving an expected heat aging resistance. Further, the antioxidant per se is an organic compound and some of antioxidants include sulfur in their molecular structures, so that the antioxidants may generate carbon monoxide, nitrogen oxide, sulfur dioxide during the combustion, thereby increasing the toxicity of combustion gases.

Therefore, in order to set the additive amount of the antioxidant as the requisite minimum, the Inventors have researched the particle diameter and additive amount of the antioxidant and have found that the optimum mean particle diameter of the antioxidant having a melting point of not less than 200 degrees Celsius is 10 μm or less, and that the optimum total amount of the antioxidant is 2 to 5 parts by mass with respect to 100 parts by mass of the polyolefin-based resin and 100 to 250 parts by mass of the metal hydroxide.

The reason for setting the mean particle diameter only for the antioxidant having a melting point of not less than 200 degrees Celsius is explained as follows. While the antioxidant having a low melting point is melted during the kneading with the polyolefin-based resin, the antioxidant having a melting point of not less than 200 degrees Celsius is not melted during the kneading with the polyolefin-based resin so that such an antioxidant remains in the matrix of the polyolefin-based resin with keeping substantially the same particle diameter as that before the kneading even after the kneading.

For the case of adding only the antioxidant having a low melting point, it is easy to achieve the dispersion of the antioxidant into the polyolefin-based resin by kneading, but the heat resistance is poor. Therefore, the antioxidant per se will be subject to thermal degradation or be volatilized to the outside of the resin at high temperatures, so that the effect of antioxidant will be significantly impaired.

Accordingly, the resin compound should include the antioxidant having a melting point of not less than 200 degrees Celsius, in order to obtain sufficient long-term heat aging resistance. Further, the additive amount of such an antioxidant should be 2 parts by mass or more with respect to 100 parts by mass of the polyolefin-based resin and 100 to 250 parts by mass of the metal hydroxide in order to be effective, but the additive amount of such an antioxidant should be not more than 5 parts by mass, since the toxicity thereof during the combustion will be increased when the additive amount exceeds 5 parts by mass.

In the present invention, the additive amount of the metal hydroxide is 100 to 250 parts by mass with respect to 100 parts by mass of the polyolefin-based resin. When the additive amount of the metal hydroxide is less than 100 parts by mass, sufficient flame retardancy will not be achieved, while when the additive amount of the metal hydroxide is more than 250 parts by mass, the mechanical properties will be reduced significantly,

The polyolefin-based resin to be used in the present invention is at least one selected from the group consisting of polypropylene, high-density polyethylene, linear low-density polyethylene, very low-density polyethylene, low-density polyethylene, α-olefin (co)polymer, ethylene-vinyl acetate copolymer, ethylene ethyl acrylate copolymer, ethylene-propylene copolymer rubber, and ethylene-propylene-diene ternary copolymer rubber.

In the present invention, the α-olefin (co) polymer means α-olefin homopolymer or α-olefin copolymer such as ethylene, propylene, 1-butene, 4-methyl-1-pentene, 1-hexene, 1-heptene, 1-octene, 1-nonene, 1-decene, or a copolymer of ethylene and these α-olefins, or mixtures thereof.

The α-olefin (co) polymer, ethylene-vinyl acetate copolymer, and ethylene-ethyl acrylate copolymer may be modified by acids, and unsaturated carboxylic acids and derivatives thereof may be used. More specifically, there are unsaturated carboxylic acids such as fumaric acid and maleic acid and derivatives of unsaturated carboxylic acids such as maleic anhydride, maleic acid monoesters, maleic acid diesters. Exemplarily, maleic acid and maleic anhydride may be used. These unsaturated carboxylic acids and derivatives thereof may be used solely or in combination.

The metal hydroxide used in the present invention is used as a flame retardant, and magnesium hydroxide and aluminum hydroxide are exemplarily used for the reason of excellent flame retardant effect and heat resistance as well as good economic efficiency. The surface of particles of the flame retardants may be surface-treated by silane coupling agent, fatty acids and the like.

The antioxidant in the present invention is not particularly limited. For example, as the first antioxidant having a melting point of not less than 200 degrees Celsius and the mean particle diameter of 10 μm or less, phenolic antioxidants, such as 1,3,5-tris(3′-5′-di-tert-butyl-4′-hydroxybenzyl)isocyanurate may be used. As the other antioxidants, e.g. phenolic antioxidants such as pentaerythrityl-tetrakis[3-[3,5-di-tert-butyl-4-hydroxyphenyl]propionate], phenol-sulfur mixed antioxidants such as thiodiethylene bis [3-[3,5-di-tert-butyl-4-hydroxyphenyl]propionate], sulfuric antioxidants such as tetrakis[methylene-3-(dodecylthio)propionate]methane, and the like may be used.

In the evaluation of the long-term heat aging resistance specified in Section 7.3 of EN50305, the halogen-free heat aging-resistant flame-retardant resin compound of the present invention is expected to have 50% or more of an elongation at break after storage for 20,000 hours at temperature of 120 degrees Celsius by the Arrhenius plot based on the maximum time for which an elongation at break of an article stored at 180 to 140 degrees Celsius is 50% or more. Further, the halogen-free heat aging-resistant flame-retardant resin compound of the present invention is characterized by that the toxicity index (ITC: The toxicity index) of the toxic gas generated during combustion prescribed in Section 9.2 of EN50305 is 3.0 or less.

Further, the wire and the cable covered with the halogen-free heat aging-resistant flame-retardant resin compound of the present invention comprises a conductor and the halogen-free heat aging-resistant flame-retardant resin compound covering the outer periphery of the conductor, which is exemplarily cross-linked by radiation, peroxides, silane crosslinking agents or the like.

Further, additives such as crosslinking agents, crosslinking aids, lubricants, softeners, plasticizers, inorganic fillers, compatibilizers, stabilizers, carbon black, colorants may be added to the halogen-free heat aging-resistant flame-retardant resin compound of the present invention, as necessary.

The specific applications of the wire and the cable covered with the halogen-free heat aging-resistant flame-retardant resin compound of the present invention are an outer insulating layer for wires for rolling stocks such as power system wires specified in EN50264-3-1, a sheath for power system cables specified in EN50264-3-2, a sheath for control system cables specified in EN50306-3, 4 and the like.

### EXAMPLES

Next, Examples of the present invention and comparative examples will be described.

The wire 10 comprising a tin-plated copper conductor 1, an inner insulating layer 2 covering an outer periphery of the tin-plated copper conductor 1, and an outer insulating layer 3 provided around the inner insulating layer 2 by extrusion-coating as shown in FIG. 1 and the halogen-free heat aging-resistant flame-retardant resin compound for the outer insulating layer 3 were prepared as described below.

A tin-plated copper stranded wires with a cross sectional area of 0.75 mm² was covered with an inner insulating layer (a resin compound including 60 parts by mass of linear low-density polyethylene, 30 parts by mass of maleic acid-modified α-olefin (co)polymer, 10 parts by mass of ethylene-ethyl acrylate copolymer, 100 parts by mass of calcined clay, 2 parts by mass of antioxidant, 1 part by mass of trimethylolpropane trimethacrylate, and 0.5 parts by mass of lubricant) in 0.8 mm thick and an outer insulating layer in 1.2 mm thick by extrusion-coating, and cross-linked by irradiation of electron beam for 8 Mrad. Here, the resin compounds for the insulators were kneaded using a pressure kneader at temperature of 180° C. before the coating process, and the kneaded mixture was pelletized for the use. The resin compounds for the outer insulating layer were blended as shown in Table 1.

The complex antioxidant in Table 1 is AO-18 (ADEKA Corporation), which is composed of a mixture of 1,3,5-tris(3′-5′-di-tert-butyl-4′-hydroxybenzyl)isocyanurate as phenolic antioxidant and tetrakis[methylene-3-(dodecylthio)propionate]methane as sulfuric antioxidant. The melting point of AO-18 is not less than 200 degrees Celsius and the mean particle diameter is 4 μm.

The phenolic antioxidant (1) is IRGANOX 1010 (Ciba Special Chemicals), which is composed of pentaerythrityl-tetrakis[3-[3,5-di-tert-butyl-4-hydroxyphenyl]propionate]. The melting point of IRGANOX 1010 is 110 to 125 degrees Celsius.

The phenolic antioxidant (2) is AO-20 (ADEKA Corporation), which is composed of 1,3,5-tris(3′-5′-di-tert-butyl-4′-hydroxybenzyl)isocyanurate. The melting point of AO-20 is 222 degrees Celsius and the mean particle diameter is 38 μm.

The phenolic antioxidants (3) and (4) were prepared by pulverizing AO-20 as the phenolic antioxidant (2) with a jet mill, and classifying the particles having the mean particle diameter of 10 μm and the particles having the mean particle diameter of 20 μm. The mean particle diameter was measured by micro-track method.

The resin compounds and the wires were rated by the following methods.

The heat aging resistance, toxicity, and mechanical properties were rated by using samples, each of which is a 1 mm thick sheet molded from the kneaded resin compound for the outer insulating layer shown in Table 1, to which electron beam was irradiated for 8 Mrad. The flame retardancy was rated by using a wire including the inner insulating layer to which electron beam was irradiated for 8 Mrad.

The heat aging resistance was rated in compliance to section 7.3 of EN50305, the toxicity was rated in compliance to Section 9.2 of EN50305, the mechanical properties were rated in compliance to Section 9.1 of EN60811-1-1, and the flame retardancy was rated in compliance to EN60332-1-2.

The heat aging resistance was rated as follows. The 1 mm thick sheet was punched into dumbbell shape to prepare dumbbell specimens, and the aging test was carried out in the aging tanks of 170 degrees Celsius, 160 degrees Celsius, and 150 degrees Celsius. Then, the tensile test was carried out on the dumbbell specimens sequentially taken out from the aging tanks, and the maximum time for maintaining the elongation at break of 50% or more (lifetime) was rated. As a result of rating, the obtained lifetime was plotted by Arrhenius method and a temperature (temperature index) at which the lifetime is 20,000 h was calculated from the regression line of the Arrhenius plot. The specimen having the temperature index of 120 or more was rated as “Pass”. The tensile test was carried out at a tension speed of 200 mm/min.

The toxicity was rated as follows. The 1 mm thick sheet was cut into 5 mm square sheets to provide specimens, and after storage for 48 hours in a room of temperature of 23 degrees Celsius and relative humidity of 50%, the specimens were decomposed for 20 minutes in a furnace at temperature of 800 degrees Celsius. From the generated amounts of hydrogen cyanide, carbon monoxide, carbon dioxide, nitrogen oxide, and sulfur dioxide and the weighting of toxicity defined in the standards, the toxicity index (ITC) was calculated for each specimen. The specimen having the toxicity of 3.0 or less was rated as “Pass”

The mechanical properties were rated as follows. The 1 mm thick sheet was punched into dumbbell shape to prepare dumbbell specimens, and a tensile test was performed at a tension speed of 200 mm/min. The specimen having the tensile strength of not less than 10 MPa and the elongation at break of not less than 125% was rated as “Pass”.

The flame retardancy was rated by Vertical Flame Test (VFT). A 600 mm-length wire was vertically supported and flamed by a burner at an inclination angle of 45 degrees for 60 seconds. The specimen in which a burned (carbonized) portion has stopped at a position distant with 50 mm or more from a top supported portion was rated as “Pass”. When all three specimens were rated as “Pass”, the flame retardancy was rated as “Total Pass” (◯).

Table 1 shows rating results of Examples prepared using the resin compound of the present invention and comparative examples prepared in the same manner as Examples.

TABLE 1
(Unit of compounding amount is parts by mass)

| | | | | Example | | | | | | | | |
|---|---|---|---|---|---|---|---|---|---|---|---|---|
| Item | | | | 1 | 2 | 3 | 4 | 5 | 6 | 7 | 8 | 9 |
| Compo- | Linear low-density polyethylene *1 | | | 50 | 50 | | | 50 | 50 | 50 | 50 | 50 |
| stions | EVA copolymer (1) *2 | | | 10 | 10 | 20 | 20 | 10 | 10 | 10 | 10 | 10 |
| | EVA copolymer (2) *3 | | | | | 60 | | | | | | |
| | EVA copolymer (3) *4 | | | | | | 20 | | | | | |
| | Ethylene-butene-1 copolymer *5 | | | 40 | 40 | 20 | | 40 | 40 | 40 | 40 | 40 |
| | Ethylene-propylene copolymer rubber *6 | | | | | | 60 | | | | | |
| | Magnesium hydroxide (1) *7 | | | 100 | 250 | 100 | | 150 | 150 | 150 | 150 | 150 |
| | Magnesium hydroxide (2) *8 | | | | | 100 | 180 | | | | | |
| | Complex antioxidant *9 | | | 1 | 1 | 1 | 3 | 0.5 | 1 | 2 | 5 | |
| | Phenolic antioxidant (1) *10 | | | 2 | 2 | 2 | | 1.5 | 1 | | | |
| | Phenolic antioxidant (2) *11 | | | | | | | | | | | |
| | Phenolic antioxidant (3) *12 | | | | | | | | | | | 1.5 |
| | Phenolic antioxidant (4) *13 | | | | | | | | | | | |
| | Sufuric antioxidant *14 | | | | | | | | | | | 1.5 |
| | Other additives (Crosslinking aid, | | | 13 | 13 | 13 | 13 | 13 | 13 | 13 | 13 | 13 |
| | Lubricant, Colorant) *15 | | | | | | | | | | | |
| Charac- | Heat aging | Temperature | 120 | 127 | 126 | 121 | 130 | 122 | 123 | 124 | 131 | 123 |
| teristics | resistance | Index (° C.) | or more | | | | | | | | | |
| | Toxicity | Toxicity | 3.0 | 3.0 | 2.6 | 2.4 | 2.7 | 2.4 | 2.8 | 2.9 | 3.0 | 2.6 |
| | | Index (ITC) | or less | | | | | | | | | |
| | Mechanical | Tensile | 10 | 12 | 10 | 13 | 12 | 11 | 11 | 11 | 11 | 11 |
| | Properties | strength | or more | | | | | | | | | |
| | | (MPa) | | | | | | | | | | |
| | | Elongation % | 125 | 170 | 125 | 145 | 180 | 155 | 150 | 160 | 150 | 145 |
| | | | or more | | | | | | | | | |
| | Flame | VFT | Total Pass | ∘ | ∘ | ∘ | ∘ | ∘ | ∘ | ∘ | ∘ | ∘ |
| | retardancy | | | | | | | | | | | |

| | | | | Comparative Example | | | | | | | |
|---|---|---|---|---|---|---|---|---|---|---|---|
| Item | | | | 1 | 2 | 3 | 4 | 5 | 6 | 7 | 8 |
| Compo- | Linear low-density polyethylene *1 | | | 50 | 50 | 50 | 50 | 50 | 50 | 50 | 50 |
| stions | EVA copolymer (1) *2 | | | 10 | 10 | 10 | 10 | 10 | 10 | 10 | 10 |
| | EVA copolymer (2) *3 | | | | | | | | | | |
| | EVA copolymer (3) *4 | | | | | | | | | | |
| | Ethylene-butene-1 copolymer *5 | | | 40 | 40 | 40 | 40 | 40 | 40 | 40 | 40 |
| | Ethylene-propylene copolymer rubber *6 | | | | | | | | | | |
| | Magnesium hydroxide (1) *7 | | | 90 | 260 | 150 | 150 | 150 | 150 | 150 | 150 |
| | Magnesium hydroxide (2) *8 | | | | | | | | | | |
| | Complex antioxidant *9 | | | 1 | 1 | 1 | 6 | | | | |
| | Phenolic antioxidant (1) *10 | | | 2 | 2 | | | | | | 1.5 |
| | Phenolic antioxidant (2) *11 | | | | | | | 1.5 | 2 | | |
| | Phenolic antioxidant (3) *12 | | | | | | | | | | |
| | Phenolic antioxidant (4) *13 | | | | | | | | | 1.5 | |
| | Sufuric antioxidant *14 | | | | | | | 1.5 | 2 | 1.5 | 1.5 |
| | Other additives (Crosslinking aid, | | | 13 | 13 | 13 | 13 | 13 | 13 | 13 | 13 |
| | Lubricant, Colorant) *15 | | | | | | | | | | |
| Charac- | Heat aging | Temperature | 120 | 128 | 127 | 115 | 135 | 119 | 122 | 118 | 117 |
| teristics | resistance | Index (° C.) | or more | | | | | | | | |
| | Toxicity | Toxicity | 3.0 | 3.1 | 2.5 | 2.8 | 3.4 | 2.8 | 3.3 | 2.7 | 2.8 |
| | | Index (ITC) | or less | | | | | | | | |
| | Mechanical | Tensile | 10 | 12 | 9 | 12 | 11 | 10 | 10 | 11 | 11 |
| | Properties | strength | or more | | | | | | | | |
| | | (MPa) | | | | | | | | | |
| | | Elongation % | 125 | 180 | 120 | 170 | 160 | 145 | 135 | 155 | 170 |
| | | | or more | | | | | | | | |
| | Flame | VFT | Total Pass | x | ∘ | ∘ | ∘ | ∘ | ∘ | ∘ | ∘ |
| | retardancy | | | | | | | | | | |

* Temperature index: Temperature at which the lifetime is 20,000 h, calculated from the Arrhenius plot of the maximum time for maintaining the elongation at break of 50% or more for articles stored at 170 degrees Celsius, 160 degrees Celsius, and 150 degrees Celsius
*1: EVOLUE SP1510,
*2: EVAFLEX 45X,
*3: LEVAPREN 600,
*4: V987,
*5: TAFMER MH5040,
*6: EP51,
*7: MAGSEEDS S4,
*8: KISUMA 5L
*9: AO-18: a mixture of 1,3,5-tris(3′-5′-di-tert-butyl-4′-hydroxybenzyl)isocyanurate and tetrakis[methylene-3-(dodecylthio)propionate]methane. The mean particle diameter is 4 μm.
*10: IRGANOX 1010: pentaerythrityl-tetrakis[3-[3,5-di-tert-butyl-4-hydroxyphenyl]propionate] The melting point is 110 to 125 degrees Celsius.
*11: AO-20: 1,3,5-tris(3′-5′-di-tert-butyl-4′-hydroxybenzyl)isocyanurate The melting point is 222 degrees Celsius and the mean particle diameter is 38 μm.
*12: Pulverized AO-20: The mean particle diameter is 10 μm
*13: Pulverized AO-20: The mean particle diameter is 20 μm
*14: SEENOX 412S: tetrakis[methylene-3-(dodecylthio)propionate]methane The melting point is 53 degrees Celsius.
*15: Crosslinking aids (trimethylolpropane trimethacrylate): 2 parts by mass, Lubricant (zinc stearate): 1 part by mass, Colorant (carbon black): 10 parts by mass

As shown in Table 1, all Examples 1 to 9 in the present invention were excellent in heat aging resistance, toxicity, mechanical properties, and flame retardancy.

Meanwhile, in comparative example 1 for which the additive amount of the metal hydroxide is less than the lower limit (100 parts by mass) of the predetermined amount range in Example 1, the flame retardancy was poor and the toxicity was insufficient.

In comparative example 2 for which the additive amount of the metal hydroxide was larger than the upper limit (250 parts by mass) of the predetermined amount range in Example 2, the mechanical properties were insufficient.

As clearly understood from Examples 1 and 2 and comparative examples 1 and 2, the additive amount of the metal hydroxide is preferably 100 to 250 parts by mass.

In comparative example 3 using a complex antioxidant as the antioxidant, the additive amount of the antioxidant was less than the lower limit (2 parts by mass) of the predetermined amount range in Example 7, and the heat aging resistance was insufficient.

In comparative example 4 for which the additive amount of the antioxidant was larger than the upper limit (5 parts by mass) of the predetermined amount range in Example 8, and the toxicity was insufficient.

As clearly understood from Examples 7 and 8 and comparative examples 3 and 4, the additive amount of the antioxidants including the antioxidant having a melting point of not less than 200 degrees Celsius is preferably 2 to 5 parts by mass.

Further, as clearly understood from Examples 5 to 8, the toxicity index increases the increase in additive amount of the complex antioxidant. In comparative example 4 using 6 parts by mass of the complex antioxidant, the toxicity index was increased, so that it is exemplary to use the complex antioxidant in combination with the other phenolic antioxidant (1). The heat aging resistance is rated as “Pass” even only 0.5 parts by mass of the antioxidant is included as long as the total additive amount of the antioxidants is within the predetermined range. Therefore, it will be sufficient if at least 0.5 parts by mass of the complex antioxidant is included.

In comparative examples 5 and 6 using the combination of the phenolic antioxidant (2) having a melting point of not less than 200 degrees Celsius and the sulfuric antioxidant, the mean particle diameter of the phenolic antioxidant (2) is 38 μm.

In the comparative example 5 for which 1.5 parts by mass of the phenolic antioxidant (2) having a melting point of not less than 200 degrees Celsius and 1.5 parts by mass of the sulfuric antioxidant were blended, the heat aging resistance was poor.

In the comparative example 6 for which 2.0 parts by mass of the phenolic antioxidant (2) having a melting point of not less than 200 degrees Celsius and 2.0 parts by mass of the sulfuric antioxidant were blended, the toxicity was insufficient.

When the particle diameter of the antioxidant is large, the dispersion of the antioxidant particles into the resin will be insufficient, so that the oxidation preventing function of the phenolic antioxidant (2) will not be fully exhibited. Therefore, when the additive amount of the phenolic antioxidant (2) is small, the oxidation preventing function will not be fully exhibited although the toxicity is sufficient. Meanwhile, when the additive amount of the phenolic antioxidant (2) is large, the toxicity will be insufficient although the oxidation preventing function is exhibited.

In comparative example 7 using a combination of the phenolic antioxidant (4) having the mean particle diameter of 20 μm and the sulfuric antioxidant, the heat aging resistance was insufficient although the toxicity was better than Example 9 using a combination of the phenolic antioxidant (3) having the mean particle diameter of 10 μm and the sulfuric antioxidant.

In comparative example 8 using a combination of the other phenolic antioxidant (1) and the sulfuric antioxidant, the heat aging resistance was insufficient.

Thus, the mean particle diameter of the phenolic antioxidant having a melting point of not less than 200 degrees Celsius is preferably 10 μm or less.

As described above, the halogen-free heat aging-resistant flame-retardant resin compound of the present invention and the wire covered therewith have excellent heat aging resistance, toxicity, mechanical properties and flame retardancy, and the industrial applicability thereof is considered to be very high.

Although the invention has been described with respect to the specific embodiment for complete and clear disclosure, the appended claims are not to be therefore limited but are to be construed as embodying all modifications and alternative constructions that may occur to one skilled in the art which fairly fall within the basic teaching herein set forth.

What is claimed is:

1. A halogen-free heat aging-resistant flame-retardant resin compound, comprising:
a mixture of 100 parts by mass of polyolefin-based resin, 100 to 250 parts by mass of metal hydroxide, and 2 to 5 parts by mass of an antioxidant including a first antioxidant having a melting point of not less than 200 degrees Celsius and a mean particle diameter of not greater than 10 μm solely or in combination with a second antioxidant, and the mixture being cross-linked.

2. The halogen-free heat aging-resistant flame-retardant resin compound according to claim 1, wherein the polyolefin-based resin is at least one selected from the group consisting of polypropylene, high-density polyethylene, linear low-density polyethylene, very low-density polyethylene, low-density polyethylene, α-olefin (co)polymer, ethylene-vinyl acetate copolymer, ethylene ethyl acrylate copolymer, ethylene-propylene copolymer rubber, and ethylene-propylene-diene ternary copolymer rubber.

3. The halogen-free heat aging-resistant flame-retardant resin compound according to claim 1, wherein the metal hydroxide is magnesium hydroxide or aluminum hydroxide.

4. The halogen-free heat aging-resistant flame-retardant resin compound according to claim 1, wherein the first antioxidant is 1,3,5-tris(3′-5′-di-tert-butyl-4′-hydroxybenzyl)isocyanurate and the second antioxidant is at least one selected from the group consisting of pentaerythrityl-tetrakis[3-[3,5-di-tert-butyl-4-hydroxyphenyl]propionate], thiodiethylene bis [3-[3,5-di-tert-butyl-4-hydroxyphenyl]propionate], and tetrakis[methylene-3-(dodecylthio)propionate]methane.

5. The halogen-free heat aging-resistant flame-retardant resin compound according to claim 1, an elongation at break after storage for 20,000 hours at temperature of 120 degrees Celsius is expected to 50% or more by Arrhenius plot based on a maximum time for which an elongation at break of an article stored at 180 to 140 degrees Celsius is 50% or more, and a toxicity index is 3.0 or less.

6. A wire comprising a conductor covered with the halogen-free heat aging-resistant flame-retardant resin compound according to claim 1.

7. A cable comprising a sheath comprising the halogen-free heat aging-resistant flame-retardant resin compound according to claim 1.
